(19) United States
(12) Patent Application Publication
(10) Pub. No.: US 2011/0192672 A1
(43) Pub. Date: Aug. 11, 2011

(54) VEHICLE CHASSIS FRAME PROVIDING DRIVE LINE OPTIMIZATION

(75) Inventors: Amrut A. Patki, Pune (IN); Juan Rodrigo de la Garza, Monterrey (MX)

(73) Assignee: International Truck Intellectual Property Company, LLC, Warrenville, IL (US)

(21) Appl. No.: 12/704,197

(22) Filed: Feb. 11, 2010

(51) Int. Cl. B60K 17/24; B21D 53/88

(52) U.S. Cl. 180/379; 29/897.2

(57) ABSTRACT

A vehicle chassis frame includes a left chassis frame rail; a right chassis frame rail; a plurality of cross members, and a mini cross member. The cross members connect the left chassis frame rail to the left chassis frame rail. The first propeller shaft is operatively configured to connect a transmission to a joint. The first propeller shaft is supported by a center bearing bracket and support. The joint is operatively configured to connect a second propeller shaft to the first propeller shaft. The second propeller shaft drives the rear axle of the vehicle. A mini-cross member may be coupled the left and right chassis frame rails proximate the joint and supports the center bearing bracket and support for the first propeller shaft.

### BACKGROUND

The present disclosure relates generally to a chassis frame for a vehicle which supports one or more propeller shafts.

Referring to FIGS. 1 and 2, in vehicles 150 such as, but not limited to semi-trucks, a front mounted engine (not shown) is generally coupled through a drive shaft 114, a differential gear (not shown) and rear axles (not shown) to drive the rear wheels 160 of the vehicle 150. Multiple drive shafts 114′, 114″, 114′″, as shown in FIG. 1, are commonly used to send power from a central differential, transmission or transaxle to the wheels 160. In front-engine, rear-drive vehicles 150, a longer drive shaft or multiple drive shafts may also be required to send power along the length of a vehicle. A Hotchkiss drive may be used where the Hotchkiss drive has two or more joints. A drive shaft connecting the gearbox to a rear differential is called a propeller shaft or prop-shaft 114. A prop-shaft assembly 114 consists of a propeller shaft 114, and joint(s) 116, 117.

Depending upon several factors including the distance between the transmission and the differential gear and the angular to the differential gear and the angular misalignment between the output of the transmission and the input to the differential gear, the drive shaft is generally in the form of a split shaft having approximately three shaft sections 114′, 114″, 114′″ with adjacent sections coupled together through a joints 116, 117 as shown in FIG. 1. For example, the output from the vehicle transmission may be coupled through a universal joint to a coupling shaft which is in turn coupled through a second universal joint to a drive shaft which is coupled through a third universal joint to the differential gear. One or more of the joints are provided in the drive shaft with, typically, one joint between the coupling shaft and the drive shaft. The joints permit variations in the spacing between the transmission and the differential gear due to manufacturing tolerances and also permit limited changes in the spacing when the differential gear moves with the rear suspension system for the vehicle. In order to provide stability for the system, it is necessary to support the coupling shaft adjacent the second joint. The rotating shaft is engaged with a bearing which is embedded in a resilient rubber busing which is in turn attached through a bracket to the vehicle chassis frame.

The propeller shaft length 114, and the number of propeller shafts 114 required and the angle of the propeller shafts are traditionally determined by cross member 118 locations to provide the required support to the drive line, and the availability of propeller shafts for the particular application. Accordingly, the propeller shaft design (consisting of the number of propeller shafts) is dependent on the locations of the cross members 118. Due to this dependency, an inefficient propeller shaft design 114 may result.

As indicated and as shown in FIG. 2, the cross members 118 are traditionally used to support propeller shafts 114′, 114″, 114′″ in a vehicle. The vehicle cross-member 118 locations along the frame rails 120, 122 (as shown in FIG. 2) is a major constraint in determining the number of propeller shafts 114′, 114″, 114′″ required on a vehicle 150. Normally, where cross-members 118 are used to support the propeller shafts 114′, 114″, 114′″, such a design requires more propeller shafts 114′, 114″, 114′″ with smaller lengths in addition to more center bearing brackets 150. See FIG. 1. Given the constraints of the cross-members 118, it may also be challenging to adjust the wheel base for a vehicle due to the available driveline combination.

### SUMMARY

A vehicle chassis frame is provided according to the embodiment(s) disclosed herein. The vehicle chassis frame includes a left chassis frame rail; a right chassis frame rail; a plurality of cross members, and a mini cross member. The cross members connect the left chassis frame rail to the left chassis frame rail. The first propeller shaft is operatively configured to connect a transmission to a joint. The first propeller shaft is supported by a center bearing bracket and support. The joint is operatively configured to connect a second propeller shaft to the first propeller shaft. The second propeller shaft drives the rear axle of the vehicle. A mini-cross member may be coupled the left and right chassis frame rails proximate the joint and supports the center bearing bracket and support for the first propeller shaft.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 side, schematic view of prior art propeller shafts that are supported by a traditional chassis frame in a truck.

FIG. 2 is a partial, perspective view of a prior art chassis frame for a truck.

FIG. 3 is a side, schematic view of propeller shafts wherein a mini-cross member of the present disclosure is supporting the propeller shaft.

FIG. 4 is a partial, perspective view of a chassis frame for the truck of FIG. 3.

FIG. 5 is an enlarged, isometric view of an embodiment of a mini-cross member of the present disclosure.

FIG. 6 is a top view of an embodiment of the mini-cross member of the present disclosure.

FIG. 7 is a front view of an embodiment of the mini-cross member of the present disclosure.

FIG. 8 is a cross sectional view of an embodiment of the mini-cross member of FIG. 5 along A-A.

FIG. 9 is a partial, perspective view of a propeller shaft supported by the mini-cross member of the present disclosure.

FIG. 10 is front view of a center bearing bracket and support with a propeller shaft disposed within the support.

FIG. 11 is a flow chart illustrating a method of manufacturing the vehicle chassis frame of the present disclosure.

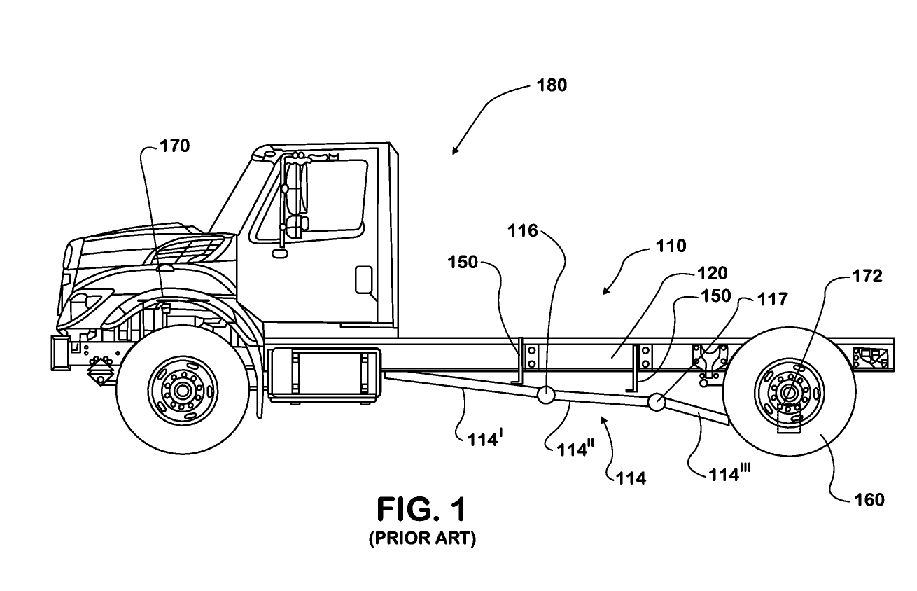

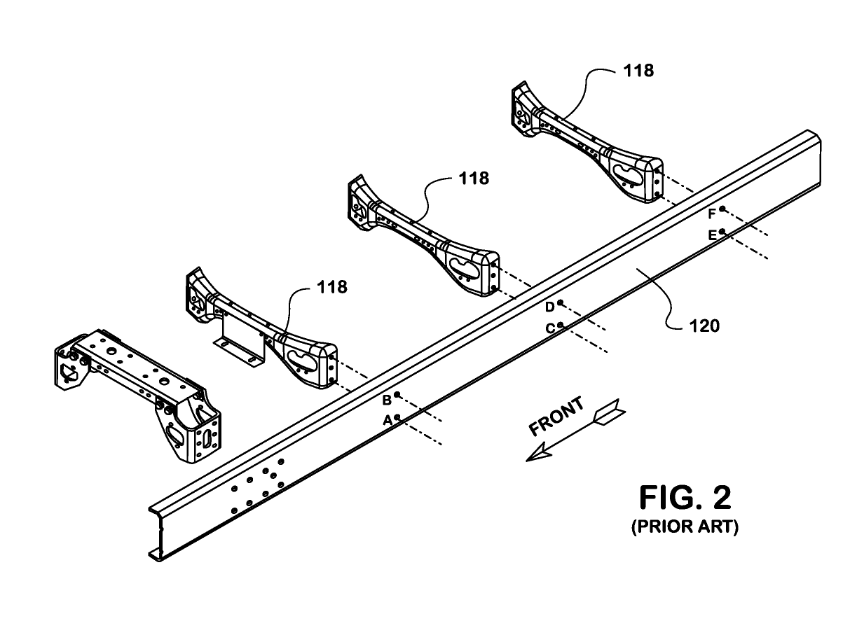

### DETAILED DESCRIPTION

The present disclosure provides a vehicle chassis frame 10 which supports one or more propeller shaft(s) 14′, 14″ which provides improved design flexibility while reducing cost and weight.

In contrast to the prior art, the present disclosure provides a vehicle chassis frame 10 which provides for drive line optimization such that the propeller shaft 14 design is not dependent on the location of the cross members 18. Rather, the propeller shaft design 14 may be optimized independent of the location of the cross members 18 given that a mini cross member 18 is implemented to support the propeller shaft. In contrast to the traditional cross members 18 of a vehicle chassis frame 10, the mini cross member 12 may be placed at any area along the length of the left chassis frame rail 20 and the right chassis frame rail 22.

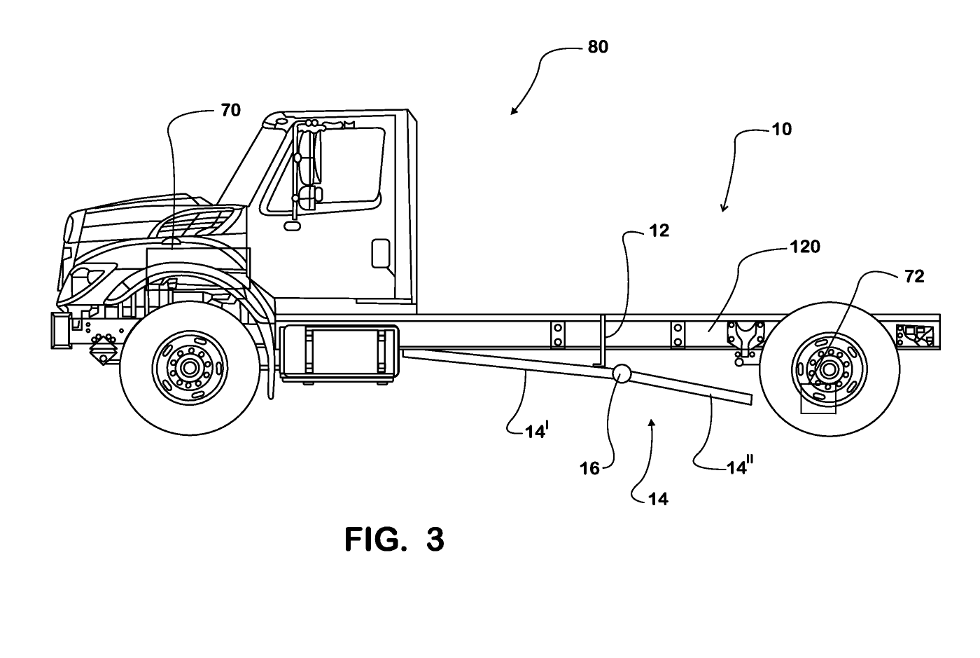

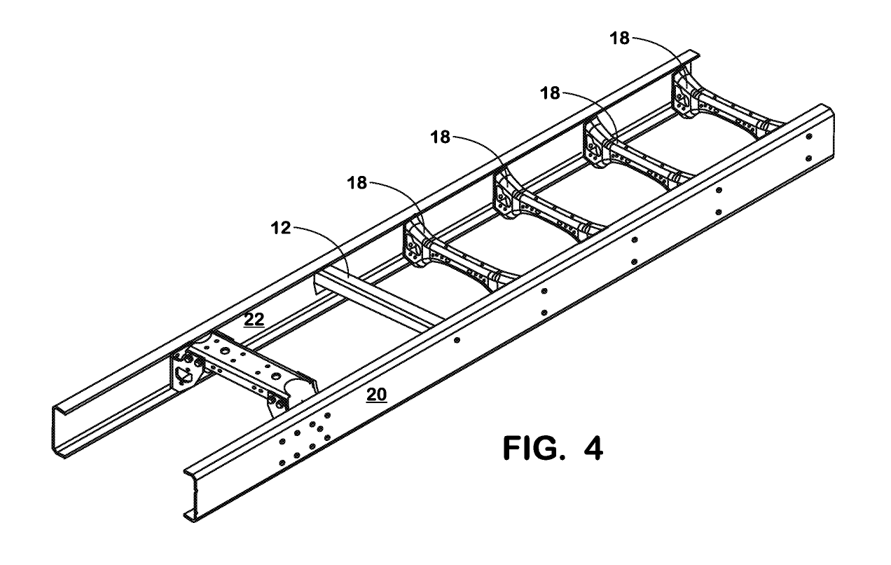

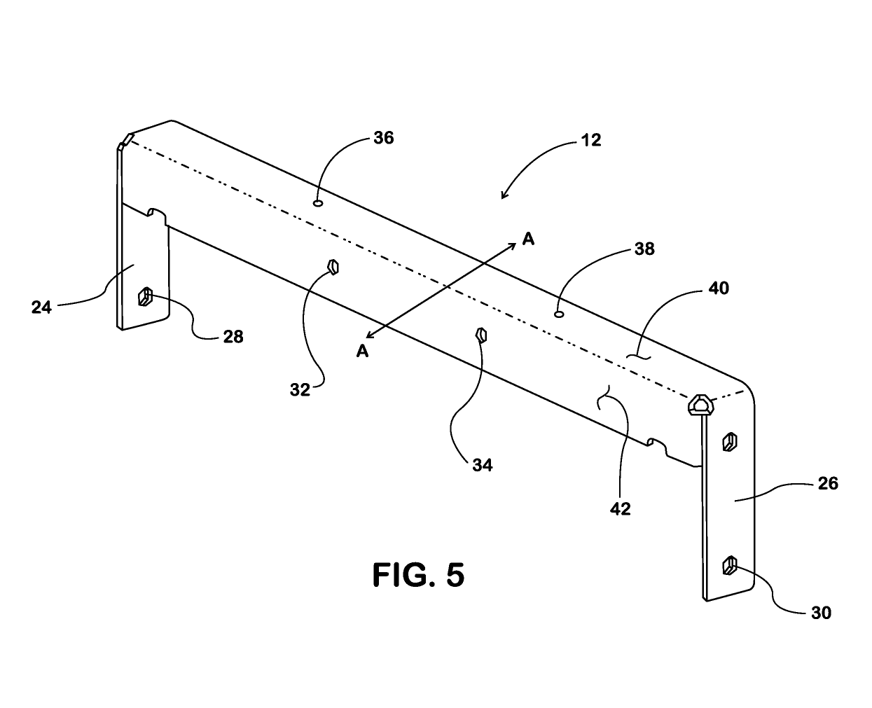

Referring now to FIG. 3, an embodiment of the vehicle chassis 10 having a mini cross member 12 is shown on a vehicle 80. The present disclosure allows for propeller shaft 14 (driveline) optimization wherein the required number of propeller shafts 14′, 14″ is reduced. This optimization may be performed without having to change the existing chassis frame 10 structure which includes the left and right frame rails 20, 22 and the cross members 18. A mini cross member 12, as shown in FIG. 5, may be implemented on the chassis frame 10 as shown in FIGS. 3 and 4 to support the propeller shaft(s) 14′, 14″ where necessary.

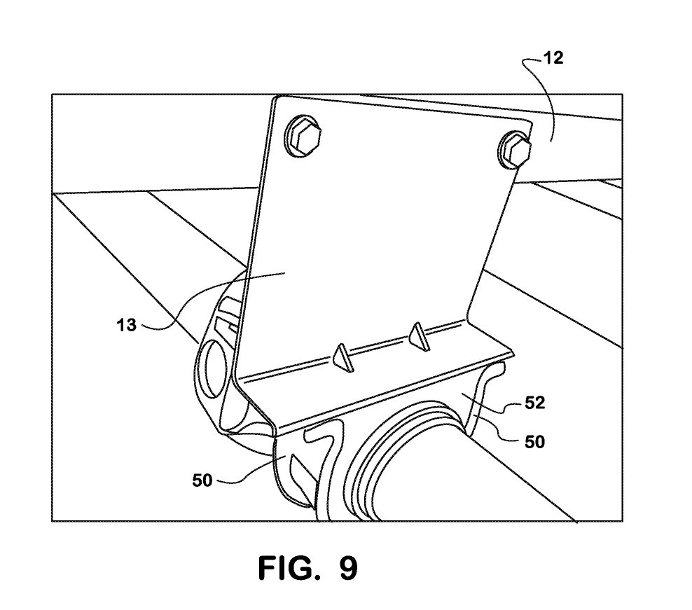

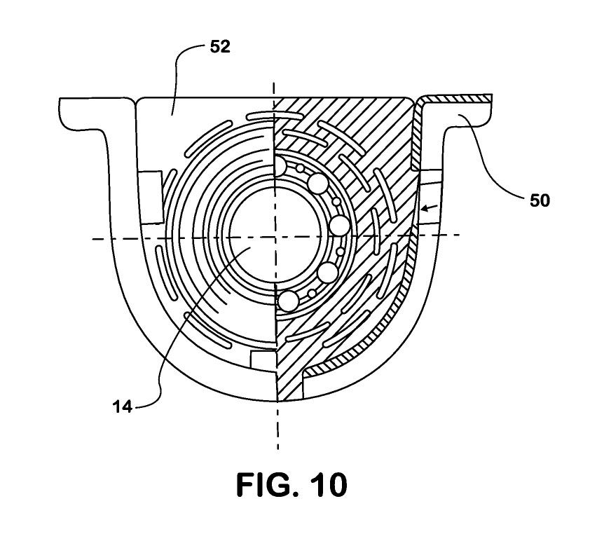

The vehicle chassis frame 10 of the present disclosure includes a left chassis frame rail 20, a right chassis frame rail 20, a plurality of cross members 18 connecting the left chassis frame rail 20 to the right chassis frame rail 22, and a first propeller shaft 14′. The first propeller shaft 14′ may connect the transmission (schematically shown as 70) to a joint 16. The first propeller shaft 14′ may supported by a center bearing bracket 50 and support 52 (as shown in FIGS. 9 and 10). The joint 16, shown in FIG. 3 is operatively configured to connect a second propeller shaft 14″ to the first propeller shaft 14′. The second propeller shaft 14″ is operatively configured to drive a rear axle 72 of the vehicle 80.

The mini-cross member 12 may be coupled to the left and right chassis frame rails 20, 22 at any area along the left and right chassis frame rails. It is to be understood that it is preferable to mount the mini cross member 12 proximate to the joint 16 as shown in FIGS. 3 and 4 given that the mini cross member may support the first propeller shaft 14′. The mini-cross member 12 may support the first propeller shaft 14′ through the center bearing bracket 50 and support 52 as shown in FIGS. 3, 9 and 10. As shown in FIG. 9, a vertical bracket 13 may be disposed between the center bearing bracket 50 and the mini cross member 12 wherein the vertical bracket 13 is mechanically fastened to the mini cross member 12 using the side apertures 32, 34 shown in FIG. 5. In yet other another option, the center bearing bracket 50 may be mounted directly to the mini cross member 12 using mechanical fasteners (not shown) through top apertures 36, 38 of the mini cross member 12 as shown in FIG. 5.

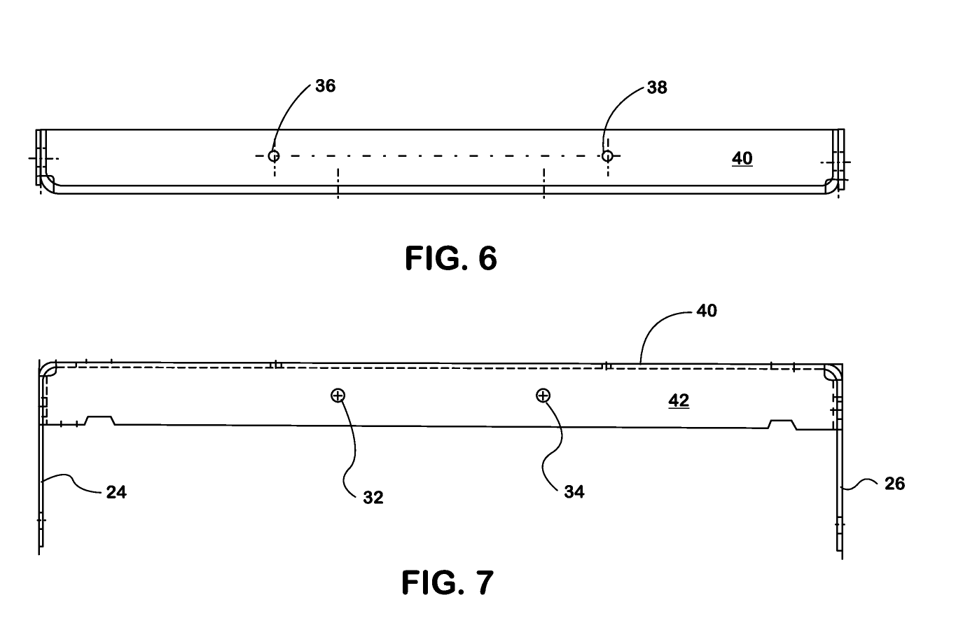

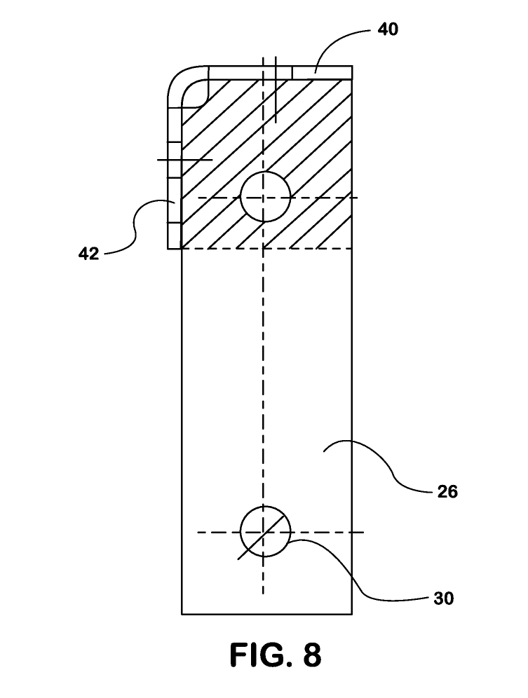

Referring now to FIG. 5-8, the mini cross member 12 is shown in greater detail. The mini cross member 12 includes a top face 40 having top apertures 36, 38. The top apertures 36, 38 may receive mechanical fasteners for joining the mini cross member 12 to another vehicle structure member, such as a center bearing bracket 50 shown in FIGS. 9 and 10. The mini cross member 12 may further have a side face 42 defining side apertures 32, 34. Side apertures 32, 34 may receive mechanical fasteners (not shown) for joining the mini cross member 12 to any other vehicle structure member.

Mini cross member 12 may also include a first leg 24 and a second leg 26. The first and second legs 24, 26 may integral to and/or disposed to the lateral sides of the top face 40 and side face 42 of the mini cross member. The first and second legs 24, 26 may provide support for the mini cross member as the mini cross member 12 is affixed to the left chassis frame rail 20 and right chassis frame rail 22. As shown in FIG. 5, the first and second legs 24, 26 may also each define leg apertures 28, 30 which further receive a mechanical fastener (not shown) for affixing the mini cross member 12 to the left and right chassis frame rails 20, 22. It is also to be understood that the mini-cross member may be affixed to the left and right chassis frame rails 20, 22 using a mechanical fasteners as shown, a welding process or the like.

As shown in FIGS. 3-9, the mini-cross member 12 is smaller than any one of the plurality of cross members 18. Accordingly, rather than using a cross member 18 to support the first propeller shaft 14′, a mini cross member 12 which is lighter in weight and lower in cost is implemented to support the first propeller shaft 14′ Furthermore, the mini cross member 14′ may be placed at any area along the left and right chassis frame rails 20, 22, thereby allowing design flexibility. The vehicle chassis frame 10 defined in claim 1 wherein the mini-cross member 12 is coupled to the left and right chassis frame rails 20, 22 via mechanical fasteners, or a welding process or the like.

As shown in FIG. 3, the mini-cross member 12 is provided between the transmission 70 and the joint 16 in order to properly support the first propeller shaft 14′ so as to allow the first propeller shaft 14′ to extend as far back as possible thereby minimizing the number of propeller shafts 14 used.

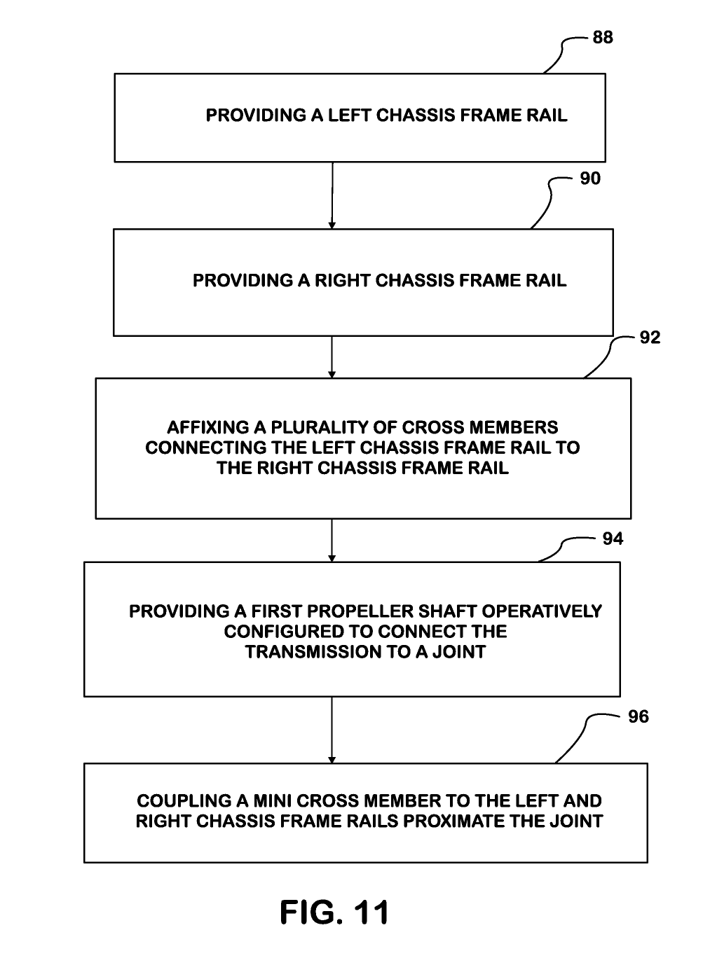

Referring now to FIG. 11, a flow chart is shown which illustrates a method for manufacturing a vehicle chassis frame 10 of the present disclosure. The method includes the steps of: providing a left chassis frame rail (step 88); providing a right chassis frame rail (step 90); affixing a plurality of cross members connecting the left chassis frame rail to the left chassis frame rail (step 92); providing a first propeller shaft operatively configured to connect the transmission to a joint (step 94), and coupling a mini-cross member to the left and right chassis frame rails proximate the joint (step 96). Again, it is understood that the mini-cross member 12 supports the center bearing bracket 50 and support 52 for the first propeller shaft 14′.

It is also understood that the first propeller shaft 14′ is supported by a center bearing bracket 50 and support 52. Again, the joint 16 connects the second propeller shaft 14″ to the first propeller shaft 14′ and the second propeller shaft 14″ operatively configured to drive the rear axle 72 of the vehicle.

While multiple embodiments have been described in detail, it will be apparent to those skilled in the art that the disclosed embodiments may be modified. Therefore, the foregoing description is to be considered exemplary rather than limiting.

What is claimed is:

1. A vehicle chassis frame comprising:
a left chassis frame rail;
a right chassis frame rail;
a plurality of cross members connecting the left chassis frame rail to the left chassis frame rail;
a first propeller shaft connecting a transmission to a joint, the first propeller shaft supported by a center bearing bracket and support, the joint operatively configured to connect a second propeller shaft to the first propeller shaft, the second propeller shaft operatively configured to drive a rear axle of the vehicle; and
a mini-cross member coupled the left and right chassis frame rails proximate the joint, the mini-cross member supporting the center bearing bracket and support for the first propeller shaft.

2. The vehicle chassis frame defined in claim 1 wherein, the mini-cross member is operatively configured to be coupled at any area along the length of the left and right chassis frame rails.

3. The vehicle chassis frame defined in claim 1 wherein the mini-cross member is smaller than any one of the plurality of cross members.

4. The vehicle chassis frame defined in claim 1 wherein the mini-cross member is coupled to the left and right chassis frame rails via a plurality of mechanical fasteners.

5. The vehicle chassis frame defined in claim 1 wherein the mini-cross member is provided between the engine and rear axle differential.

6. A method for manufacturing a vehicle chassis frame comprising the steps of:
providing a left chassis frame rail;
providing a right chassis frame rail;
affixing a plurality of cross members connecting the left chassis frame rail to the left chassis frame rail;
providing a first propeller shaft operatively configured to connecting transmission to a joint, the first propeller shaft supported by a center bearing bracket and support, the joint connecting a second propeller shaft to the first propeller shaft, the second propeller shaft operatively configured to drive the rear axle of the vehicle; and
coupling a mini-cross member to the left and right chassis frame rails in an area along the left and right chassis frame rails to optimize the length of the first propeller shaft and to optimize the drive line angle of the first propeller shaft and the second propeller shaft, the mini-cross member operatively configured to support the center bearing bracket and support for the first propeller shaft.

7. The method for manufacturing a vehicle chassis frame defined in claim 6 wherein, the mini-cross member is operatively configured to be coupled at any area along the length of the left and right chassis frame rails.

8. The method for manufacturing a vehicle chassis frame defined in claim 6 wherein the mini-cross member is smaller than any one of the plurality of cross members.

9. The method for manufacturing a vehicle chassis frame defined in claim 6 wherein the mini-cross member is coupled to the left and right chassis frame rails via a plurality of mechanical fasteners.

10. The method for manufacturing a vehicle chassis frame defined in claim 1 wherein the mini-cross member is provided between the engine and the rear axle differential.
